(19) United States
(12) Patent Application Publication
(10) Pub. No.: US 2024/0005061 A1
(43) Pub. Date: Jan. 4, 2024

(54) METHOD AND DEVICE FOR PREDICTING INSULATION AGING LIFE OF HIGH-VOLTAGE SUBMARINE CABLE

(71) Applicant: ELECTRIC PWR. RES. INST., CHINA SOUTH. PWR. GRID, Guangzhou (CN)

(72) Inventors: Shuai HOU, Guangzhou (CN); Mingli FU, Guangzhou (CN); Lingmeng FAN, Guangzhou (CN); Xiaolin LI, Guangzhou (CN); Lei JIA, Guangzhou (CN); Yunpeng ZHAN, Guangzhou (CN); Wenbo ZHU, Guangzhou (CN); Baojun HUI, Guangzhou (CN); Bin FENG, Guangzhou (CN); Yifan ZHANG, Guangzhou (CN)

(73) Assignee: ELECTRIC PWR. RES. INST., CHINA SOUTH. PWR. GRID, Guangzhou (CN)

(21) Appl. No.: 18/215,986

(22) Filed: Jun. 29, 2023

(30) Foreign Application Priority Data
Jun. 29, 2022 (CN) 202210752856.9

(51) Int. Cl. G06F 30/20

(52) U.S. Cl. CPC G06F 30/20

(57) ABSTRACT

The present disclosure relates to the field of high-voltage AC cable insulation technologies, and provides a method for predicting insulation aging life of a high-voltage submarine cable and a device. The method includes: obtaining environmental data and cable breakdown time of a cable sample; the environmental data including an electric field, temperature, and mechanical stress applied to the cable sample by an environment; calculating characteristic breakdown time corresponding to the cable sample by Weibull distribution based on the cable breakdown time of the cable sample; determining an insulation aging life prediction model of the high-voltage submarine cable based on the environmental data and the characteristic breakdown time of the cable sample; obtaining environmental data of a cable to be predicted in an actual application environment, and calculating insulation aging life of the cable to be predicted by using the prediction model.

### CROSS-REFERENCE TO RELATED APPLICATIONS

The present application claims priority to Chinese patent application No. 2022107528569, filed on Jun. 29, 2022, the entire content of which is incorporated herein by reference.

### TECHNICAL FIELD

The present disclosure relates to the field of high-voltage alternating current (AC) cable insulation technologies, and in particular, to a method and a device for predicting insulation aging life of a high-voltage submarine cable.

### BACKGROUND

In recent years, with the continuous improvement of economic level and the continuous advancement of the “dual-carbon” strategy, the proportion of electricity in terminal energy consumption has also increased. With the rapid development of offshore wind power technology, the voltage level of high-voltage submarine cables is also increasing. Therefore, it is very important to ensure the reliable operation of high-voltage submarine cables, and it is necessary to predict the insulation aging life of high-voltage submarine cables under a combined effect of multiple physical fields.

### SUMMARY

A first aspect of the present disclosure provides a method for predicting insulation aging life of a high-voltage submarine cable. The method includes: obtaining environmental data and cable breakdown time of a cable sample; the environmental data including an electric field, temperature, and mechanical stress applied to the cable sample by an environment; calculating characteristic breakdown time corresponding to the cable sample by Weibull distribution based on the cable breakdown time of the cable sample; determining an insulation aging life prediction model of the high-voltage submarine cable based on the environmental data and the characteristic breakdown time of the cable sample; and obtaining environmental data of a cable to be predicted in an actual application environment, and calculating insulation aging life of the cable to be predicted by using the prediction model.

In some embodiments, the calculating characteristic breakdown time corresponding to the cable sample by the Weibull distribution based on the cable breakdown time of the cable sample includes: fitting the cable breakdown time of the cable sample to obtain a corresponding Weibull distribution model, the Weibull distribution model being denoted as:

$$P ( t , α , β ) = 1 - {e}^{- {( \frac{t}{α} )}^{β}} ,$$

where P is a breakdown probability, α is a scale coefficient of the breakdown time, β is a shape coefficient of the breakdown time, and t is the breakdown time; and obtaining the characteristic breakdown time corresponding to the cable sample by using the Weibull distribution model based on a preset breakdown probability.

In some embodiments, the determining the insulation aging life prediction model of the high-voltage submarine cable based on the environmental data and the characteristic breakdown time of the cable sample includes: inputting environmental data and characteristic breakdown time of each two of n groups of cable samples into a cable insulation aging life coefficient model in an electro-thermo-mechanical composite field, respectively, and determining the insulation aging life prediction model of the high-voltage submarine cable based on the cable insulation aging life coefficient model in the electro-thermo-mechanical composite field; the n being an integer not less than six, and at least one of the environmental data of all groups of cable samples being different; and the cable insulation aging life coefficient model in the electro-thermo-mechanical composite field being denoted as:

$$\frac{{L}_{0}}{{L}_{1}} = \frac{{L}_{E 0}}{{L}_{E 1}} \cdot \frac{{L}_{T 0}}{{L}_{T 1}} \cdot \frac{{L}_{M 0}}{{L}_{M 1}} \cdot G ( E , T , M ) ,$$

where E₀, T₀, M₀, E₁, T₁ and M₁ are respectively the electric field intensity, temperature and mechanical stress of the environment where the two groups of cable samples are located; L₀ is the insulation life under conditions of the electric field intensity E₀, temperature T₀, and mechanical stress M₀; L₁ is the insulation life under conditions of the electric field intensity E₁, temperature T₁, and mechanical stress M₁; L_{E0}, L_{T0}, and L_{M0} are the insulation life under an effect of a single factor of the electric field intensity E₀, temperature T₀, and mechanical stress M₀, respectively; L_{E1}, L_{T1} and L_{M1} are the insulation life under the effect of the single factor of the electric field intensity E₁, temperature T₁, and mechanical stress M₁, respectively; and G is a correlation coefficient of the electric field, temperature and mechanical stress.

In some embodiments, a ratio of LE0 to LE1 is determined by an electric field insulation life model based on values of the electric field intensity E0 and E0, and the electric field insulation life model is denoted as:

$$\frac{{L}_{E 0}}{{L}_{E 1}} = exp [ - h ( {E}_{0} - {E}_{1} ) ] ,$$

where h is an aging coefficient under a single effect of the electric field;
a ratio of L_{T0} to L_{T1} is determined by a temperature insulation life model based on a value of the temperature T₀, and the temperature insulation life model is denoted as:

$$\frac{{L}_{T 0}}{{L}_{T 1}} = exp ( - {kT}_{0} ) ,$$

where k is an aging coefficient under a single effect of the temperature; and
a ratio of L_{M0} to L_{M1} is determined by a mechanical stress insulation life model based on values of the mechanical stress M₀ and M₁, and the mechanical stress insulation life model is denoted as:

$$\frac{{L}_{M 0}}{{L}_{M 1}} = exp [ - m ( {M}_{0} - {M}_{1} ) ] ,$$

where m is an aging coefficient under a single effect of the mechanical stress.

In some embodiments, a value of G is determined by a correlation coefficient model of an electro-thermo-mechanical multi-physical field based on values of the electric field intensity E0 and E1, a value of the temperature T, and values of the mechanical stress M0 and M1, and the correlation coefficient model of the electro-thermo-mechanical multi-physical field is denoted as:

G(E,T,M)=exp┌n(E−E₀)T+n′(M−M₀)(E−E₀)+n″(M−M₀)T┐,

where n is a correlation coefficient between the electric field and the temperature, n′ is a correlation coefficient between the electric field and the mechanical stress, and n″ is a correlation coefficient between the temperature and the mechanical stress.

In some embodiments, the determining the insulation aging life prediction model of the high-voltage submarine cable based on the cable insulation aging life coefficient model in the electro-thermo-mechanical composite field includes: calculating values of coefficients h, k, m, n, n′ and n″ based on the cable insulation aging life coefficient model in the electro-thermo-mechanical composite field, and determining the insulation aging life prediction model of the high-voltage submarine cable using the coefficients; and determining the insulation aging life prediction model of the high-voltage submarine cable using the coefficients; the insulation aging life prediction model of the high-voltage submarine cable being denoted as:

L=L₀·exp{┌−h+nT+n′(M−M₀)┐(E−E₀)+(−m+n″T)(M−M₀)−kT},

where L is insulation aging prediction life of a high-voltage submarine cable to be predicted, and E, T and M are the electric field intensity, the temperature, and the mechanical stress of the high-voltage submarine cable to be predicted in the actual application environment respectively.

In some embodiments, the obtaining the environmental data of the cable sample includes: obtaining setting parameters of an electric field thermostat where the cable sample is located and a mechanical stress device to which the cable sample is mounted.

In some embodiments, the temperature set in the electric field thermostat is within the range of 50˜150° C., the electric field intensity set in the electric field thermostat is within the range of 40˜80 kV/mm, and a tension and compression stress applied by the mechanical stress device is within the range of 0˜10 Mpa.

A second aspect of the present disclosure provides an apparatus for predicting insulation aging life of a high-voltage submarine cable. The apparatus includes: a cable sample experiment module configured to obtain environmental data and cable breakdown time of a cable sample; the environmental data including an electric field, temperature, and mechanical stress applied to the cable sample by an environment; a characteristic breakdown time calculation module configured to calculate characteristic breakdown time corresponding to the cable sample by Weibull distribution based on the cable breakdown time of the cable sample; a cable insulation aging life prediction model determination module configured to determine an insulation aging life prediction model of the high-voltage submarine cable based on the environmental data and the characteristic breakdown time of the cable sample; and a cable insulation aging life prediction module configured to obtain environmental data of a cable to be predicted in an actual application environment, and calculate insulation aging life of the cable to be predicted by using the prediction model.

A third aspect of the present disclosure provides a device for predicting insulation aging life of a high-voltage submarine cable. The device includes at least one processor and at least one memory. The at least one memory stores program codes and is configured to transmit the program codes to the at least one processor. The at least one processor is configured to execute the method for predicting insulation aging life of the high-voltage submarine cable of any one of the first aspect of the present disclosure based on instructions in the program codes.

### BRIEF DESCRIPTION OF THE DRAWINGS

In order to describe the technical solutions in the embodiments of the present disclosure more clearly, the accompanying drawings required for describing the embodiments or for describing the conventional art will be briefly introduced as follows. Apparently, the accompanying drawings in the following description shows merely some embodiments of the present disclosure, for those of ordinary skill in the art, other drawings can also be obtained according to these accompanying drawings without making any creative efforts.

FIG. 1 is a flow chart showing a method for predicting insulation aging life of a high-voltage submarine cable according to an embodiment of the present disclosure.

FIG. 2 is a flow chart showing a calculation of characteristic breakdown time in the method for predicting the insulation aging life of the high-voltage submarine cable according to an embodiment of the present disclosure.

FIG. 3 is a flow chart showing a prediction model determination in the method for predicting the insulation aging life of the high-voltage submarine cable according to an embodiment of the present disclosure.

FIG. 4 is a flow chart showing an electrothermal field experiment in the method for predicting the insulation aging life of the high-voltage submarine cable according to an embodiment of the present disclosure.

FIG. 5 is a general flow chart showing a method for predicting insulation aging life of a high-voltage submarine cable.

FIG. 6 is a diagram showing a configuration of an apparatus for predicting insulation aging life of a high-voltage submarine cable.

### DETAILED DESCRIPTION OF THE EMBODIMENTS

In order to make the purpose, technical solutions and advantages of embodiments of the present disclosure more clearly understood, the technical solutions in the embodiments will be described clearly and completely below with reference to the accompanying drawings in the embodiments of the present disclosure. Obviously, the described embodiments are a part of but not all of the embodiments of the present disclosure. Based on the embodiments in the present disclosure, all other embodiments obtained without any creative efforts by a person of ordinary skill in the art fall within the scope of protection of the present disclosure.

Due to the complex effects of multiple physical fields such as electric field, thermal field, and mechanical stress, the insulation aging law of high-voltage submarine cables is very complicated, and a life evaluation is difficult. According to the characteristics of insulation aging, scholars put forward some empirical models to reflect the aging law of insulation materials, such as an inverse power model, an exponential model, an Arrhenius model, a RAMU model, etc. However, the above models also show obvious deficiencies in an application process. For example, the inverse power model and the Arrhenius model can only describe an aging process under a single factor of the electric field or the thermal field. When an electrothermal factor is applied to the insulation materials at the same time, time of the aging life is significantly shortened, so that the inverse power model and the Arrhenius model cannot accurately reflect the actual insulation aging life of the high-voltage AC cables. The RAMU model is based on the classical inverse power function law of electrical aging of single stress, and the constant of the inverse power function law is set as a coefficient related to temperature, so as to reflect the influence of the electric field and temperature on the insulation aging life. However, an evaluation error of the RAMU model is large, and an applicable range is small, so it is difficult to accurately evaluate the insulation aging life of the high-voltage AC cables. Furthermore, the influence of the mechanical stress on the insulation aging life has rarely been studied, and the insulation aging life under the combined effect of the electric field, the thermal field and the mechanical stress is even less involved.

The present disclosure provides a method for predicting insulation aging life of a high-voltage submarine cable, which is used for solving the problem of an inaccurate evaluation of the life of the high-voltage submarine cable in related art.

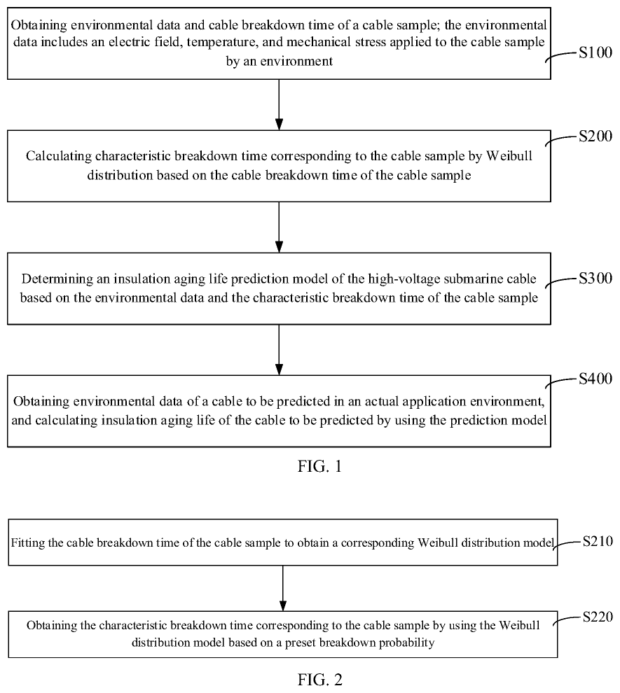

Referring to FIG. 1, FIG. 1 is a flow chart showing a method for predicting insulation aging life of a high-voltage submarine cable provided by an embodiment of the present disclosure.

In step S100, environmental data and cable breakdown time of a cable sample are obtained. The environmental data includes an electric field, temperature, and mechanical stress applied to the cable sample by the environment.

It should be noted that in the present embodiment, the cable sample is first placed in a composite field of the electric field, temperature, and mechanical stress while controlling the electric field intensity, the temperature, and the mechanical stress applied to the cable sample of the composite field at a constant preset value. Further, the environmental data of the cable sample, i.e., values of the electric field intensity, the temperature, and the mechanical stress, are obtained, and then the cable breakdown time required for the cable sample to be broken down in the multi-physical composite field is recorded.

In step S200, characteristic breakdown time corresponding to the cable sample is calculated by Weibull distribution based on the cable breakdown time of the cable sample.

It should be noted that the cable breakdown time of the cable sample is fitted to a double-coefficient Weibull distribution curve, and the characteristic breakdown time corresponding to the group of cable samples under electrothermal data is obtained by the Weibull distribution.

In step S300, an insulation aging life prediction model of the high-voltage submarine cable is determined based on the environmental data and the characteristic breakdown time of the cable sample.

It should be noted that in the present embodiment, based on the characteristic breakdown time of the cable sample obtained under a combined effect of the electric field, the temperature and the mechanical stress, the insulation aging life prediction model of the high-voltage submarine cable that reflects the influence of the electric field, the temperature and the mechanical stress on the insulation life is determined.

In step S400, environmental data of a cable to be predicted in an actual application environment is obtained, and insulation aging life of the cable to be predicted is calculated by using the prediction model.

It should be noted that the insulation aging life prediction model of the high-voltage submarine cable reflects the effects of the electric field, the temperature, and the mechanical stress on the insulation aging life. The corresponding insulation aging life can be obtained by inputting the electric field intensity, the temperature and the mechanical stress applied to the cable to be predicted in the application environment into the insulation aging life prediction model of the high-voltage submarine cable for calculation.

In this embodiment, the characteristic breakdown time of the cable sample is calculated by the Weibull distribution, then the insulation aging life prediction model of the high-voltage submarine cable is determined, and finally the insulation aging life of the cable to be predicted is calculated by inputting the environmental data of the cable to be predicted. The characteristic breakdown time calculated by the Weibull distribution reflects the characteristics of the cable under an electrothermal field. The life prediction model embodies the changing law of the insulation aging life of the cable under the combined effect of the electric field, the temperature, and the mechanical stress, and can effectively and accurately predict the life of the cable under the corresponding multi-physical composite field.

The above is a detailed description of a first embodiment of the method for predicting the insulation aging life of the high-voltage submarine cable provided by the present disclosure, and the following is a detailed description of a second embodiment of the method for predicting the insulation aging life of the high-voltage submarine cable provided by the present disclosure.

Referring to FIG. 2, FIG. 2 is a flow chart showing a calculation of characteristic breakdown time in the method for predicting the insulation aging life of the high-voltage submarine cable. In the step S200 of the previous embodiment, the characteristic breakdown time corresponding to the cable sample is calculated by Weibull distribution based on the cable breakdown time of the cable sample, which specifically includes the following steps.

In step S210, the cable breakdown time of the cable sample is fitted to obtain a corresponding Weibull distribution model.

It should be noted that the Weibull distribution model is denoted as:

$$P ( t , α , β ) = 1 - {e}^{- {( \frac{t}{α} )}^{β}} ,$$

where P is a breakdown probability, α is a scale coefficient of the breakdown time, β is a shape coefficient of the breakdown time, and t is the breakdown time.

The number of samples in each group of cable samples is 5-10. The breakdown time of multiple cables in the same group are fitted to a double-coefficient Weibull distribution, and the scale coefficient α of the breakdown time and the shape coefficient β of the breakdown time are obtained to obtain the Weibull distribution model corresponding to the group of cable samples.

Further, the sample number of 5-10 per group of cable samples in the present embodiment improves the efficiency of the Weibull distribution fitting. However, in the actual prediction experiment, the number of samples in each group of cable samples can be selected to be larger than 10, so that the more cables in each group of cable samples, the more breakdown time can be obtained for fitting, and the Weibull distribution obtained by fitting is more accurate.

In step S220, the characteristic breakdown time corresponding to the cable sample is obtained by using the Weibull distribution model based on a preset breakdown probability.

It should be noted that in the present embodiment, the preset breakdown probability is 63.2%, which corresponds to average life of the cable, i.e., mathematical expectation of the life of the cable in the Weibull distribution.

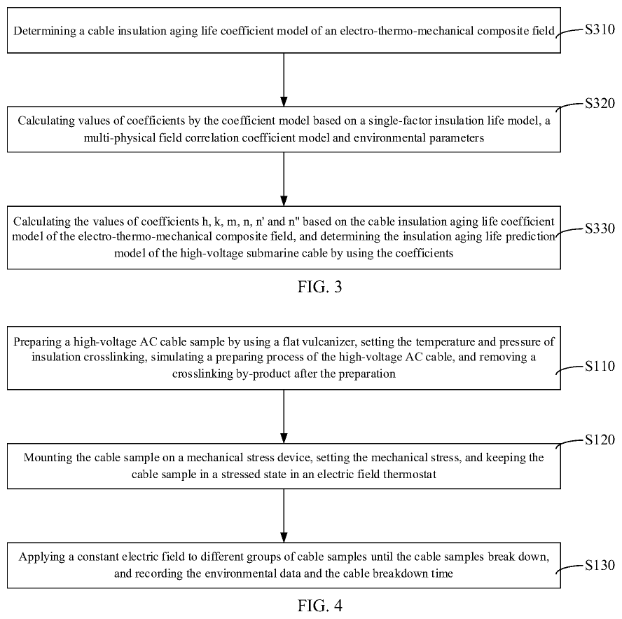

Referring to FIG. 3, FIG. 3 is a flow chart showing a prediction model determination in the method for predicting the insulation aging life of the high-voltage submarine cable. In the step S300 of the previous embodiment, the insulation aging life prediction model of the high-voltage submarine cable is determined based on the environmental data and the characteristic breakdown time of the cable sample, which specifically includes the following steps.

In step S310, a cable insulation aging life coefficient model in an electro-thermo-mechanical composite field is determined.

The cable insulation aging life coefficient model in the electro-thermo-mechanical composite field is denoted as:

$$\frac{{L}_{0}}{{L}_{1}} = \frac{{L}_{E 0}}{{L}_{E 1}} \cdot \frac{{L}_{T 0}}{{L}_{T 1}} \cdot \frac{{L}_{M 0}}{{L}_{M 1}} \cdot G ( E , T , M ) ,$$

where E₀, T₀, M₀, E₁, T₁ and M₁ are the electric field intensity, temperature, and mechanical stress of the environment where two groups of cable samples are located, respectively. L₀ is the insulation life under the conditions of the electric field intensity E₀, temperature T₀, and mechanical stress M₀. L₁ is the insulation life under the conditions of the electric field intensity E₁, temperature T₁, and mechanical stress M₁. L_{E0}, L_{T0}, and L_{M0} are the insulation life under the effect of a single factor of the electric field intensity E₀, temperature T₀, and mechanical stress M₀, respectively. L_{E1}, L_{T1} and L_{M1} are the insulation life under the effect of the single factor of the electric field intensity E₁, temperature T₁, and mechanical stress M₁, respectively. G is a correlation coefficient of the electric field, temperature, and mechanical stress.

It should be noted that the insulation life under the effect of the single factor refers to the insulation life that only the electric field intensity or the temperature or the mechanical stress changes, while other environmental parameters do not change. It is to be understood that the insulation life under the effect of the single factor depends on the data of two groups of cable samples, i.e., the effect of the single factor can only be reflected under a ratio of L_{E0} to L_{E1}, a ratio of L_{T0} to L_{T1}, and a ratio of L_{M0} to L_{M1}.

Further, the insulation life based on the effects of multiple single factors can also predict the insulation aging life of the cable. A value of G can be calculated based on the insulation life of six groups of cable samples affected by the single factor and the insulation life of two groups of cable samples affected by the multi-physical field. Then the single factor of each physical field of the multi-physical composite field of the cable to be predicted is retained, and the three insulation lives of the cable to be predicted in the actual application environment affected by the single factor are calculated. Combining the insulation lives of another three groups of cable samples affected by the single factor and the insulation life of a group of cable samples affected by the multi-physical field, the insulation aging life of the cable to be predicted under the multi-physical composite field can be calculated.

In step S320, values of coefficients are calculated by the cable insulation aging life coefficient model in the electro-thermo-mechanical composite field based on a single-factor insulation life model, a multi-physical field correlation coefficient model and environmental parameters.

It should be noted that the ratio of L_{E0} to L_{E1} is determined by an electric field insulation life model based on values of the electric field intensity E₀ and E₁. The electric field insulation life model is denoted as:

$$\frac{{L}_{E 0}}{{L}_{E 1}} = exp [ - h ( {E}_{0} - {E}_{1} ) ] .$$

The ratio of L_{T0} to L_{T1} is determined by a temperature insulation life model based on a value of the temperature T₀, and the temperature insulation life model is denoted as:

$$\frac{{L}_{T 0}}{{L}_{T 1}} = exp ( - {kT}_{0} ) .$$

The ratio of L_{M0} to L_{M1} is determined by a mechanical stress insulation life model based on values of the mechanical stress M₀ and M₁, and the mechanical stress insulation life model is denoted as:

$$\frac{{L}_{M 0}}{{L}_{M 1}} = exp [ - m ( {M}_{0} - {M}_{1} ) ] .$$

The value of G is determined by a correlation coefficient model of an electro-thermo-mechanical multi-physical field based on the values of the electric field intensity E₀ and E₁, a value of the temperature T, and the values of the mechanical stress M₀ and M₁, and the correlation coefficient model of the electro-thermo-mechanical multi-physical field is denoted as:

G(E,T,M)=exp┌n(E−E₀)T+n′(M−M₀)(E−E₀)+n″(M−M₀)T┐,

where h is an aging coefficient under a single effect of the electric field, k is an aging coefficient under a single effect of the temperature, m is an aging coefficient under a single effect of the mechanical stress, n is a correlation coefficient between the electric field and the temperature, n′ is a correlation coefficient between the electric field and the mechanical stress, and n″ is a correlation coefficient between the temperature and the mechanical stress.

Finally, the cable insulation aging life coefficient model in the electro-thermo-mechanical composite field is obtained, denoted as:

$$\frac{{L}_{0}}{{L}_{1}} = exp \{ [ - h + {nT}_{1} + {n}^{′} ( {M}_{0} - {M}_{1} ) ] ( {E}_{0} - {E}_{1} ) + ( - m + {n}^{″} {T}_{1} ) ( {M}_{0} - {M}_{1} ) - {kT}_{1} \} .$$

In step S330, the values of coefficients h, k, m, n, n′ and n″ are calculated based on the cable insulation aging life coefficient model in the electro-thermo-mechanical composite field, and the insulation aging life prediction model of the high-voltage submarine cable is determined by using the coefficients.

The insulation aging life prediction model of the high-voltage submarine cable is denoted as:

L=L₀·exp{┌−h+nT+n′(M−M₀)┐(E−E₀)+(−m+n″T)(M−M₀)−kT},

where L is insulation aging prediction life of a high-voltage submarine cable to be predicted, and E, T and M are the electric field intensity, the temperature, and the mechanical stress of the actual application environment of a submarine cable to be predicted, respectively.

In the present embodiment, the characteristic breakdown time of the cable sample is calculated by the Weibull distribution, and then the cable insulation aging life coefficient model in the electro-thermo-mechanical composite field is determined. Further, the coefficients are calculated based on the single-factor insulation life model, the multi-physical field correlation coefficient model, and the environmental parameters, and then the insulation aging life prediction model of the high-voltage submarine cable that reflects the effects of three factors of electric field, temperature, and mechanical stress on insulation aging life is determined. The characteristic breakdown time calculated by the Weibull distribution describes the characteristics of the cable under the electrothermal field. The insulation aging life prediction model of the high-voltage submarine cable embodies the changing law of the insulation aging life of the cable under the combined effect of the electric field, the temperature, and the mechanical stress, and optimizes the calculation of the model, which can effectively and accurately predict the life of the cable under the corresponding multi-physical composite field.

The above is a detailed description of the second embodiment of the method for predicting the insulation aging life of the high-voltage submarine cable provided by the present disclosure, and the following is a detailed description of a third embodiment of the method for predicting the insulation aging life of the high-voltage submarine cable provided by the present disclosure.

Referring to FIG. 4, FIG. 4 is a flow chart showing an electrothermal field experiment in the method for predicting the insulation aging life of the high-voltage submarine cable. In the step S100 of the previous embodiment, the environmental data and the cable breakdown time of the cable sample are obtained, the environmental data includes the electric field, the temperature, and the mechanical stress applied to the cable sample by the environment, and the step S100 specifically includes the following steps.

In step S110, a high-voltage AC cable sample is prepared by using a flat vulcanizer, the temperature and pressure of insulation crosslinking are set, a preparing process of the high-voltage AC cable is simulated, and a crosslinking by-product is removed after the preparation.

It should be noted that in the present embodiment, the obtained cable sample is a flat sample prepared by simulating the cable to be predicted using the flat vulcanizer and using the insulation material of the cable to be predicted, which facilitates the acquisition of the electrothermal data and the cable breakdown time, as well as the subsequent life prediction. In the actual prediction, the same cable entity as the cable to be predicted can also be used to calculate the electrothermal data and the cable breakdown time. In the present embodiment, the crosslinking temperature of the flat vulcanizer is set at 180° C., the pressure is 15 MPa, the preparation process lasts 15 min, and a diameter of the prepared cable sample is 50 mm. After finishing the preparation, the cable sample is then placed in a vacuum drying oven at 60° C. for more than 24 h to remove the crosslinking by-product.

In step S120, the cable sample is mounted on a mechanical stress device, the mechanical stress is set, and the cable sample is kept in a stressed state in an electric field thermostat.

It should be noted that in order to simulate the water pressure received by the submarine cable in seawater, the mechanical stress device applies a uniform pressure between the upper and lower surfaces of the flat cable sample to simulate the pressure state of the submarine cable in the seawater. Different groups of cable samples are set with different tension and compression stresses, and the tension and compression stress applied by the mechanical stress device can be within the range of 0˜10 Mpa.

Further, an electrode in the electric field thermostat is a columnar metal electrode with a chamfer radius within the range of 0.5˜1 mm. In the present embodiment, the electrode used is a brass column electrode with a diameter of 25 mm and the chamfer radius of 1 mm. The temperature of the electric field thermostat is within the range of 50˜150° C., and the electric field strength is within the range of 40˜80 kV/mm.

In step S130, a constant electric field is applied to different groups of cable samples until the cable samples break down, and the environmental data and the cable breakdown time are recorded.

It should be noted that the cable sample is placed in the electric field thermostat before the experiment, then the temperature of the thermostat is adjusted to be an experimental temperature, and the temperature is left to stabilize for at least 30 minutes so that the electrode and the sample reached a constant experimental temperature. The electric field intensity, the temperature, and the mechanical stress of the environment to which the cable sample is exposed are maintained until the cable sample breaks down, and the environmental parameters corresponding to each group of cable samples, as well as the cable breakdown time, are recorded.

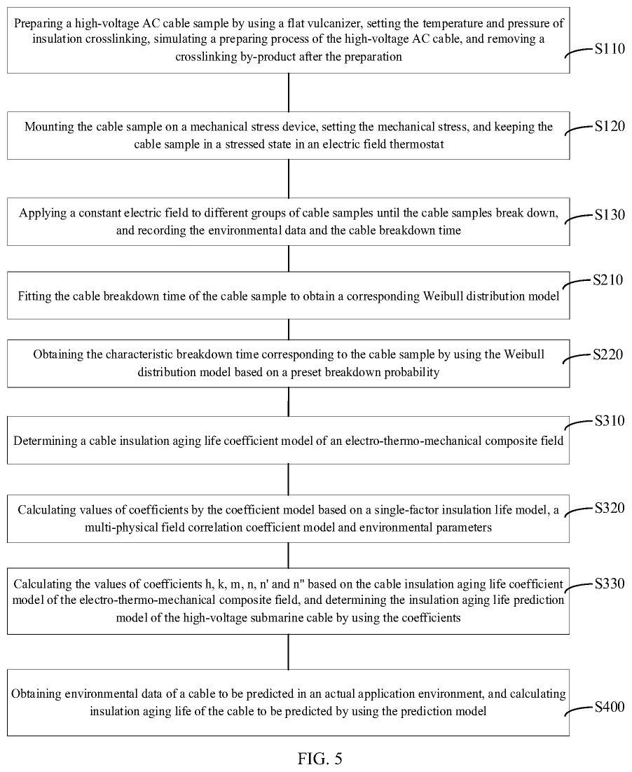

Further, referring to FIG. 5, FIG. 5 is a general flow chart showing the method for predicting the insulation aging life of the high-voltage submarine cable. The contents of the steps in FIG. 5 can be referred to the corresponding processes in the previous embodiments and will not be repeated here.

In the present embodiment, after processing multiple groups of cable samples, the mechanical stress is applied to the cable samples to simulate the pressure state of the bottom of the sea. Then the cable samples are placed in different electric field thermostats to apply the temperature and the electric field to establish electro-thermo-mechanical multi-physical composite fields, and the corresponding cable breakdown times are measured to provide data for the calculation of the coefficients in the subsequent steps. The data reflect the changing law of the insulation aging life under the combined effect of the electric field, the temperature, and the mechanical stress, and can efficiently and accurately predict the life of cable under the corresponding multi-physical composite field.

The above is a detailed description of the third embodiment of the method for predicting the insulation aging life of the high-voltage submarine cable provided by the present disclosure, and the following is a detailed description of an apparatus for predicting insulation aging life of a high-voltage submarine cable provided by the second aspect of the present disclosure.

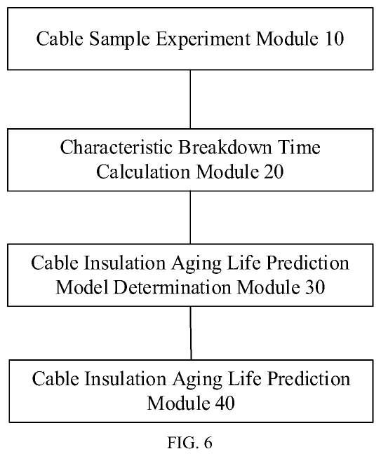

Referring to FIG. 6, FIG. 6 is a diagram showing the apparatus for predicting the insulation aging life of the high-voltage submarine cable. The apparatus includes the following modules.

A cable sample experiment module 10 is configured to obtain environmental data and cable breakdown time of a cable sample. The environmental data includes an electric field, temperature, and mechanical stress applied to the cable sample by the environment.

A characteristic breakdown time calculation module 20 is configured to calculate characteristic breakdown time corresponding to the cable sample by Weibull distribution based on the cable breakdown time of the cable sample.

A cable insulation aging life prediction model determination module 30 is configured to determine an insulation aging life prediction model of the high-voltage submarine cable based on the environmental data and the characteristic breakdown time of the cable sample.

A cable insulation aging life prediction module 40 is configured to obtain environmental data of a cable to be predicted in an actual application environment, and calculate insulation aging life of the cable to be predicted by using the prediction model.

The above modules may be implemented in whole or in part by software, hardware, and combinations thereof. Each of the above modules may be embedded in or independent of a processor in a computer device in a form of hardware, or may be stored in a memory of the computer device in a form of software, so as to be called by the processor to perform the operations corresponding to the above modules.

A third aspect of the present disclosure further provides a device for predicting insulation aging life of a high-voltage submarine cable. The device includes at least one processor and at least one memory. The at least one memory stores program codes and is configured to transmit the program codes to the at least one processor. The at least one processor is configured to execute the above method for predicting insulation aging life of the high-voltage submarine cable based on instructions in the program codes.

It will be clear to those skilled in the art that, for the convenience and brevity of description, the specific working processes of the apparatus and device described above can be referred to the corresponding processes in the preceding method embodiments and will not be repeated here.

In the embodiments provided in the present disclosure, it should be understood that the disclosed system, apparatus and method, may be implemented in other ways. For example, the above described embodiments of the apparatus are only illustrative, for example, the division of the modules is only a logical functional division, and during an actual implementation, there may be another division. For example, multiple modules or components may be combined or integrated into another system, or some features may be ignored or may not be implemented. In addition, the shown or discussed mutual coupling or direct coupling or communication connection may be the indirect coupling or the communication connections through some interfaces, devices, or units, and may be in an electrical, mechanical, or other form.

The modules illustrated as separate components may be physically separated or not, and the components displayed as modules may be physical modules or not, i.e., they may be located in one place, or may be distributed on a plurality of network units. Some or all of these units may be selected according to actual needs to achieve the purpose of the solution of the present embodiment.

In addition, each functional module in each embodiment of the present disclosure may be integrated in one processing unit, or each module may be arranged physically and separately, or two or more modules may be integrated in one module. The above integrated modules can be implemented either in the form of hardware or software functional units.

The integrated modules, when implemented in form of software functional units and sold or used as separate products, may be stored in a computer readable storage medium. Based on this understanding, the technical solutions of the embodiments of the present disclosure, or the part that contributes to the prior art, or part of the technical solutions may essentially be embodied in the form of a software product. The computer software product is stored in a storage medium and includes a number of instructions to cause a computer device (which may be a personal computer, a server, or a network device, etc.) to perform all or part of the steps of the method described in the various embodiments of the present disclosure. And the aforementioned storage medium includes: a U disk, a mobile hard disk, a read-only memory (ROM), a random access memory (RAM), a disk, a CD, or other various mediums that may store program codes.

As stated above, the above embodiments are used only to illustrate the technical solutions of the present disclosure, and not to limit them. Despite the detailed description of the present disclosure with reference to the foregoing embodiments, it should be understood by those of ordinary skill in the art that it is still possible to modify the technical solutions documented in the foregoing embodiments or to make equivalent substitutions for some of the technical features thereof And these modifications or substitutions do not take the essence of the corresponding technical solutions out of the spirit and scope of the technical solutions of the various embodiments of the present disclosure.

What is claimed is:

1. A method for predicting insulation aging life of a high-voltage submarine cable, the method comprising:
obtaining environmental data and cable breakdown time of a cable sample, the environmental data comprising an electric field, a temperature, and a mechanical stress applied to the cable sample by an environment;
calculating characteristic breakdown time corresponding to the cable sample by Weibull distribution based on the cable breakdown time of the cable sample;
determining an insulation aging life prediction model of the high-voltage submarine cable based on the environmental data and the characteristic breakdown time of the cable sample; and
obtaining environmental data of a cable to be predicted in an actual application environment, and calculating insulation aging life of the cable to be predicted by using the prediction model.

2. The method of claim 1, wherein the calculating characteristic breakdown time corresponding to the cable sample by the Weibull distribution based on the cable breakdown time of the cable sample comprises:
fitting the cable breakdown time of the cable sample to obtain a corresponding Weibull distribution model, the Weibull distribution model being denoted as:
$$P ( t , α , β ) = 1 - {e}^{- {( \frac{t}{α} )}^{β}} ,$$
where P is a breakdown probability, α is a scale coefficient of the breakdown time, β is a shape coefficient of the breakdown time, and t is the breakdown time; and
obtaining the characteristic breakdown time corresponding to the cable sample by using the Weibull distribution model based on a preset breakdown probability.

3. The method of claim 1, wherein the determining the insulation aging life prediction model of the high-voltage submarine cable based on the environmental data and the characteristic breakdown time of the cable sample comprises:
inputting the environmental data and characteristic breakdown time of each two of n groups of cable samples into a cable insulation aging life coefficient model in an electro-thermo-mechanical composite field, respectively, and determining the insulation aging life prediction model of the high-voltage submarine cable based on the cable insulation aging life coefficient model in the electro-thermo-mechanical composite field; the n being an integer not less than six, and at least one of the environmental data of all groups of cable samples being different; and
the cable insulation aging life coefficient model in the electro-thermo-mechanical composite field being denoted as:
$$\frac{{L}_{0}}{{L}_{1}} = \frac{{L}_{E 0}}{{L}_{E 1}} \cdot \frac{{L}_{T 0}}{{L}_{T 1}} \cdot \frac{{L}_{M 0}}{{L}_{M 1}} \cdot G ( E , T , M ) ,$$
where E₀, T₀, M₀, E₁, T₁ and M₁ are respectively the electric field intensity, temperature and mechanical stress of the environment where the two groups of cable samples are located; L₀ is the insulation life under conditions of the electric field intensity E₀, temperature T₀, and mechanical stress M₀; L₁ is the insulation life under conditions of the electric field intensity E₁, temperature T₁, and mechanical stress M₁; L_{E0}, L_{T0}, and L_{M0} are the insulation life under an effect of a single factor of the electric field intensity E₀, temperature T₀, and mechanical stress M₀, respectively; L_{E1}, L_{T1} and L_{M1} are the insulation life under the effect of the single factor of the electric field intensity E₁, temperature T₁, and mechanical stress M₁, respectively; and G is a correlation coefficient of the electric field, temperature and mechanical stress.

4. The method of claim 3, wherein a ratio of L_{E0} to L_{E1} is determined by an electric field insulation life model based on values of the electric field intensity E₀ and E1, and the electric field insulation life model is denoted as:
$$\frac{{L}_{E 0}}{{L}_{E 1}} = exp [ - h ( {E}_{0} - {E}_{1} ) ] ,$$
where h is an aging coefficient under a single effect of the electric field;
wherein a ratio of L_{T0} to L_{T1} is determined by a temperature insulation life model based on a value of the temperature T₀, and the temperature insulation life model is denoted as:
$$\frac{{L}_{T 0}}{{L}_{T 1}} = exp ( - {kT}_{0} ) ,$$
where k is an aging coefficient under a single effect of the temperature; and
wherein a ratio of L_{M0} to L_{M1} is determined by a mechanical stress insulation life model based on values of the mechanical stress M₀ and M₁, and the mechanical stress insulation life model is denoted as:
$$\frac{{L}_{M 0}}{{L}_{M 1}} = exp [ - m ( {M}_{0} - {M}_{1} ) ] ,$$
where m is an aging coefficient under a single effect of the mechanical stress.

5. The method of claim 3, wherein a value of G is determined by a correlation coefficient model of an electro-thermo-mechanical multi-physical field based on values of the electric field intensity E₀ and E₁, a value of the temperature T, and values of the mechanical stress M₀ and M₁, and the correlation coefficient model of the electro-thermo-mechanical multi-physical field is denoted as:
G(E,T,M)=exp┌n(E−E₀)T+n′(M−M₀)(E−E₀)+n″(M−M₀)T┐,
where n is a correlation coefficient between the electric field and the temperature, n′ is a correlation coefficient between the electric field and the mechanical stress, and n″ is a correlation coefficient between the temperature and the mechanical stress.

6. The method of claim 5, wherein the determining the insulation aging life prediction model of the high-voltage submarine cable based on the cable insulation aging life coefficient model in the electro-thermo-mechanical composite field comprises:
calculating values of coefficients h, k, m, n, n′ and n″ based on the cable insulation aging life coefficient model in the electro-thermo-mechanical composite field, and determining the insulation aging life prediction model of the high-voltage submarine cable using the coefficients;
the insulation aging life prediction model of the high-voltage submarine cable being denoted as:
L=L₀·exp{┌−h+nT+n′(M−M₀)┐(E−E₀)+(−m+n″T)(M−M₀)−kT},
where L is insulation aging prediction life of a high-voltage submarine cable to be predicted, and E, T and M are the electric field intensity, the temperature, and the mechanical stress of the high-voltage submarine cable to be predicted in the actual application environment respectively.

7. The method of claim 1, wherein the obtaining the environmental data of the cable sample comprises:
obtaining setting parameters of an electric field thermostat where the cable sample is located and a mechanical stress device to which the cable sample is mounted.

8. The method of claim 7, wherein the temperature set in the electric field thermostat is within the range of 50˜150° C., the electric field intensity set in the electric field thermostat is within the range of 40˜80 kV/mm, and a tension and compression stress applied by the mechanical stress device is within the range of 0˜10 Mpa.

9. A device for predicting insulation aging life of a high-voltage submarine cable, the device comprising at least one processor and at least one memory;
wherein the at least one memory stores program codes and is configured to transmit the program codes to the at least one processor; and
the at least one processor is configured to execute a method for predicting insulation aging life of the high-voltage submarine cable based on instructions in the program codes, the method comprising:
obtaining environmental data and cable breakdown time of a cable sample, the environmental data comprising an electric field, a temperature, and a mechanical stress applied to the cable sample by an environment;
calculating characteristic breakdown time corresponding to the cable sample by Weibull distribution based on the cable breakdown time of the cable sample;
determining an insulation aging life prediction model of the high-voltage submarine cable based on the environmental data and the characteristic breakdown time of the cable sample; and
obtaining environmental data of a cable to be predicted in an actual application environment, and calculating insulation aging life of the cable to be predicted by using the prediction model.

10. The device of claim 9, wherein the calculating characteristic breakdown time corresponding to the cable sample by the Weibull distribution based on the cable breakdown time of the cable sample comprises:
fitting the cable breakdown time of the cable sample to obtain a corresponding Weibull distribution model, the Weibull distribution model being denoted as:
$$P ( t , α , β ) = 1 - {e}^{- {( \frac{t}{α} )}^{β}} ,$$
where P is a breakdown probability, α is a scale coefficient of the breakdown time, β is a shape coefficient of the breakdown time, and t is the breakdown time; and
obtaining the characteristic breakdown time corresponding to the cable sample by using the Weibull distribution model based on a preset breakdown probability.

11. The device of claim 9, wherein the determining the insulation aging life prediction model of the high-voltage submarine cable based on the environmental data and the characteristic breakdown time of the cable sample comprises:
inputting the environmental data and characteristic breakdown time of each two of n groups of cable samples into a cable insulation aging life coefficient model in an electro-thermo-mechanical composite field, respectively, and determining the insulation aging life prediction model of the high-voltage submarine cable based on the cable insulation aging life coefficient model in the electro-thermo-mechanical composite field; the n being an integer not less than six, and at least one of the environmental data of all groups of cable samples being different; and
the cable insulation aging life coefficient model in the electro-thermo-mechanical composite field being denoted as:
$$\frac{{L}_{0}}{{L}_{1}} = \frac{{L}_{E 0}}{{L}_{E 1}} \cdot \frac{{L}_{T 0}}{{L}_{T 1}} \cdot \frac{{L}_{M 0}}{{L}_{M 1}} \cdot G ( E , T , M ) ,$$
where E₀, T₀, M₀, E₁, T₁ and M₁ are respectively the electric field intensity, temperature and mechanical stress of the environment where the two groups of cable samples are located; L₀ is the insulation life under conditions of the electric field intensity E₀, temperature T₀, and mechanical stress M₀; L₁ is the insulation life under conditions of the electric field intensity E₁, temperature T₁, and mechanical stress M₁; L_{E0}, L_{T0}, and L_{M0} are the insulation life under an effect of a single factor of the electric field intensity E₀, temperature T₀, and mechanical stress M₀, respectively; L_{E1}, L_{T1} and L_{M1} are the insulation life under the effect of the single factor of the electric field intensity E₁, temperature T₁, and mechanical stress M₁, respectively; and G is a correlation coefficient of the electric field, temperature and mechanical stress.

12. The device of claim 11, wherein a ratio of L_{E0} to L_{E1} is determined by an electric field insulation life model based on values of the electric field intensity E₀ and E1, and the electric field insulation life model is denoted as:
$$\frac{{L}_{E 0}}{{L}_{E 1}} = exp [ - h ( {E}_{0} - {E}_{1} ) ] ,$$
where h is an aging coefficient under a single effect of the electric field;
wherein a ratio of L_{T0} to L_{T1} is determined by a temperature insulation life model based on a value of the temperature T₀, and the temperature insulation life model is denoted as:
$$\frac{{L}_{T 0}}{{L}_{T 1}} = exp ( - {kT}_{0} ) ,$$
where k is an aging coefficient under a single effect of the temperature; and
wherein a ratio of L_{M0} to L_{M1} is determined by a mechanical stress insulation life model based on values of the mechanical stress M₀ and M₁, and the mechanical stress insulation life model is denoted as:
$$\frac{{L}_{M 0}}{{L}_{M 1}} = exp [ - m ( {M}_{0} - {M}_{1} ) ] ,$$
where m is an aging coefficient under a single effect of the mechanical stress.

13. The device of claim 11, wherein a value of G is determined by a correlation coefficient model of an electro-thermo-mechanical multi-physical field based on values of the electric field intensity E₀ and E₁, a value of the temperature T, and values of the mechanical stress M₀ and M₁, and the correlation coefficient model of the electro-thermo-mechanical multi-physical field is denoted as:
G(E,T,M)=exp┌n(E−E₀)T+n′(M−M₀)(E−E₀)+n″(M−M₀)T┐,
where n is a correlation coefficient between the electric field and the temperature, n′ is a correlation coefficient between the electric field and the mechanical stress, and n″ is a correlation coefficient between the temperature and the mechanical stress.

14. The device of claim 13, wherein the determining the insulation aging life prediction model of the high-voltage submarine cable based on the cable insulation aging life coefficient model in the electro-thermo-mechanical composite field comprises:
calculating values of coefficients h, k, m, n, n′ and n″ based on the cable insulation aging life coefficient model in the electro-thermo-mechanical composite field, and determining the insulation aging life prediction model of the high-voltage submarine cable using the coefficients;
the insulation aging life prediction model of the high-voltage submarine cable being denoted as:
L=L₀·exp{┌−h+nT+n′(M−M₀)┐(E−E₀)+(−m+n″T)(M−M₀)−kT},
where L is insulation aging prediction life of a high-voltage submarine cable to be predicted, and E, T and M are the electric field intensity, the temperature, and the mechanical stress of the high-voltage submarine cable to be predicted in the actual application environment respectively.

15. The device of claim 9, wherein the obtaining the environmental data of the cable sample comprises:
obtaining setting parameters of an electric field thermostat where the cable sample is located and a mechanical stress device to which the cable sample is mounted.

16. The device of claim 15, wherein the temperature set in the electric field thermostat is within the range of 50˜150° C., the electric field intensity set in the electric field thermostat is within the range of 40˜80 kV/mm, and a tension and compression stress applied by the mechanical stress device is within the range of 0˜10 Mpa.
